(19) United States
(12) Patent Application Publication
(10) Pub. No.: US 2009/0178038 A1
(43) Pub. Date: Jul. 9, 2009

(54) OPERATION MANAGEMENT SYSTEM, OPERATION MANAGEMENT METHOD, RECORDING MEDIUM STORING OPERATION MANAGEMENT PROGRAM, AND DATA SIGNAL

(75) Inventor: Hiroshi KATSURABAYASHI, Kawasaki-shi (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/203,812

(22) Filed: Sep. 3, 2008

(30) Foreign Application Priority Data
Jan. 7, 2008 (JP) 2008-000537

(51) Int. Cl. G06F 9/44

(52) U.S. Cl. 718/1

(57) ABSTRACT

An operation management system, which includes: a document management device that manages a document; and a document operation device that requests to view or obtains the document, in which the document management device includes: an operation restriction information management section that manages first operation restriction information for restricting an operation of the document for which viewing is requested and which is operated by a user, and second operation restriction information generated from the first operation restriction information, for restricting the operation of the document obtained from the document management device and operated by the user; and an issuance section that issues the second operation restriction information to the document operation device, and the document operation device includes an operation restriction section that restricts the operation based on the second operation restriction information when the document is obtained from the document management device.

### CROSS-REFERENCE TO RELATED APPLICATION

This application is based on and claims priority under 35 USC 119 from Japanese Patent Application No. 2008-000537 filed on Jan. 7, 2008.

### BACKGROUND

1. Technical Field

The present invention relates to an operation management system, an operation management method, a recording medium storing an operation management program, and a data signal.

2. Related Art

For the purpose of ensuring confidentiality of a document managed by a document management device, there have been proposed, for example, a method of setting operation authority to the document to restrict allowable operations using the operation authority, and a method of replacing a specific portion (phrase, etc.) with alternative letters at the time of viewing the document.

Additionally, to ensure the confidentiality when printing operation for the document is allowed under the operation authority, and a printed matter material out through the printing operation is taken away, there has been provided a method of managing a discarding state of the printed material.

### SUMMARY

An aspect of the present invention provides an operation management system, which includes: a document management device that manages a document; and a document operation device that makes a viewing request to view or obtains a document managed by the document management device to operate, in which the document management device includes: an operation restriction information management section that manages first operation restriction information for restricting an operation of the document for which viewing is requested from the document operation device to the document management device to operate and which is operated by a user of the document operation device, and second operation restriction information generated on the basis of the first operation restriction information, for restricting the operation of the document obtained from the document management device by the document operation device to operate and operated by the user of the document operation device; and an issuance section that issues the second operation restriction information managed by the operation restriction information management section to the document operation device, and the document operation device includes an operation restriction section that restricts an operation of the document on the basis of the second operation restriction information issued by the issuance section when the document is obtained from the document management device to operate.

### BRIEF DESCRIPTION OF THE DRAWINGS

An exemplary embodiment of the present invention will be described in detail based on the following figures, wherein:

FIG. 1 is a diagram showing a system configuration of an operation management system according to an exemplary embodiment of the present invention;

FIG. 2 is a block diagram showing a functional configuration of the operation management system according to the exemplary embodiment of the present invention;

FIG. 3 is a diagram showing a schematic configuration of the operation management system according to the exemplary embodiment of the present invention;

FIG. 4 is a sequence diagram showing a state transition diagram of the operation management system according to the exemplary embodiment of the present invention;

FIG. 5 is a diagram showing one example of an access ticket;

FIG. 6 is a flow chart illustrating a flow of processing of a client PC in the operation management system according to the exemplary embodiment of the present invention;

FIGS. 7A and 7B are table configuration diagrams showing restriction information at the time of operating the document in a managed state in the operation management system according to the exemplary embodiment of the present invention;

FIG. 8 is a table configuration diagram showing information for managing a document that is made into a non-managed state in the operation management system according to the exemplary embodiment of the present invention;

FIGS. 9A and 9B are diagrams showing examples of operation restriction information for restricting operations of the document that is made into the non-managed state in the operation management system according to the exemplary embodiment of the present invention; and

FIGS. 10A and 10B are diagrams showing source information that forms the basis for generating the operation restriction information in the non-managed state shown in FIGS. 9A and 9B.

### DETAILED DESCRIPTION

Referring now to attached drawings, an example of an operation management system, an operation management method, a recording medium storing an operation management program, and a data signal according to the present invention will be described in detail.

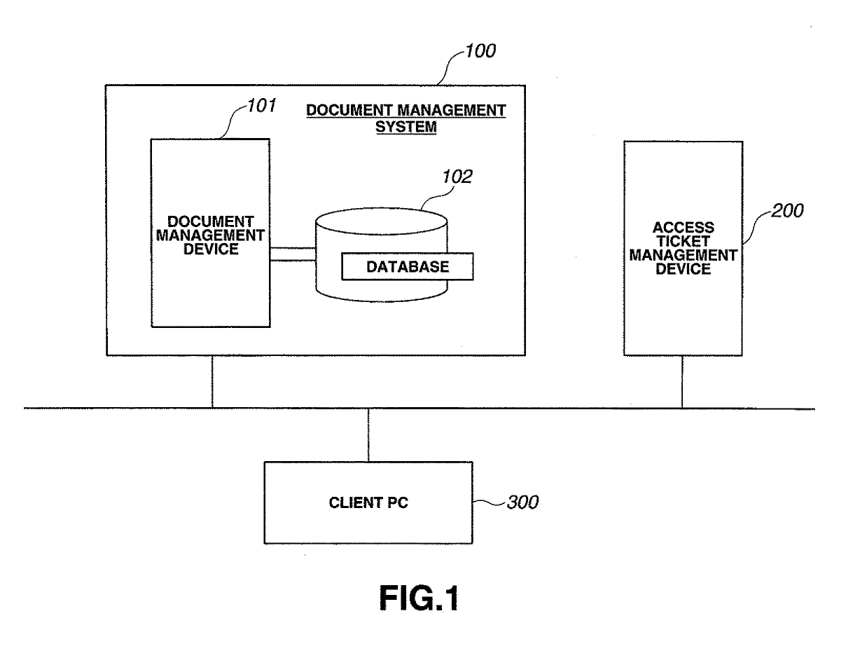

FIG. 1 is a diagram showing a system configuration of the operation management system according to an exemplary embodiment of the present invention.

In FIG. 1, the operation management system includes a document management system 100, an access ticket management device 200, and a client PC 300. The document management system 100 includes a document management device 101, and a database 102.

The document management device 101 manages operation restriction information for restricting each user's document operation for each document to be operated. Only the document operation permitted by the operation restriction information managed by the document management device 101 can be performed using the client PC 300.

In the database 102, a document of which operation is restricted by the operation restriction information managed by the document management device 101 is registered. At the time of operating the document using the client PC 300, an operation request is made from the client PC 300 to the document management device 101.

For example, at the time of viewing a document managed by the document management device 101 using the client PC 300, it is determined whether to permit the user who makes the request to view the document on the basis of the operation restriction information in a case where the document exits in a document management unit managed by the document management device 101.

Additionally, as for operational restriction on a document removed from the document management device 101, the operation restriction information is notified to the access ticket management device in conjunction with an ID of the document while an encrypted document is downloaded. In the document management device 101, the operation restriction information for the removed document in this case is set separately from the operation restriction information of the document existing in the document management unit managed by the document management device 101.

The operation management system can separately restrict operations on the basis of different pieces of operation restriction information, that is, in the case where the document managed by the document management device 101 is viewed and operated, and in the case where the document is obtained from the document management device through such a manner as download, in other words, in the case where the document is removed and is operated.

Hereinafter, the operation restriction information applied to the former case is referred to as “first operation restriction information,” and the operation restriction information applied to the latter case is referred to as “second operation restriction information.” Note that, when separation is not necessary, the wording “operation restriction information” is collectively used.

Additionally, a state where the document is managed in the document management device is indicated as “managed state.” And, a state where the document is removed from the document management device through such a manner as download is indicated as “non-managed state.”

The document of which operation is restricted by the operation restriction information managed by the document management device 101 is registered in the database 102. To operate the document using the client PC 300, a request to view the document or a request to download the document (obtainment request) is made from the client PC 300 to the document management device 101. In the case when the document is operated through making the viewing request, the document operation permitted by the first operation restriction information can be performed. However, detailed description of this configuration is omitted because this configuration is similar to some conventional arts.

The document management device 101 retrieves from the database 102 the document of which download is requested, generates the second operation restriction information for the document, and registers it. As the operation restriction, information for capsulizing the document such as an encryption key is specified in this second operation restriction information. By applying an encryption algorithm by using the encryption key to encrypt the document, a capsulized document is generated.

Then, the generated capsulized document is sent to the client PC 300, which is a download requester.

At this time, the document management document 101 sends to the access ticket management device 200 document information of a document to be operated together with the operation restriction information to be applied to the document. After receiving those pieces of information, the access ticket management device 200 manages those pieces of information while associating the document information with the second operation restriction information.

After downloading the capsulized document, the client PC 300 then requests an access ticket including the information necessary for operating the capsulized document from the access ticket management device 200.

The access ticket management device 200 generates the access ticket on the basis of the access ticket request made from the client PC 300. In the access ticket request, the capsulized document to be operated in the client PC 300 is specified. The access ticket management device 200 generates the access ticket by using the registered second operation restriction information.

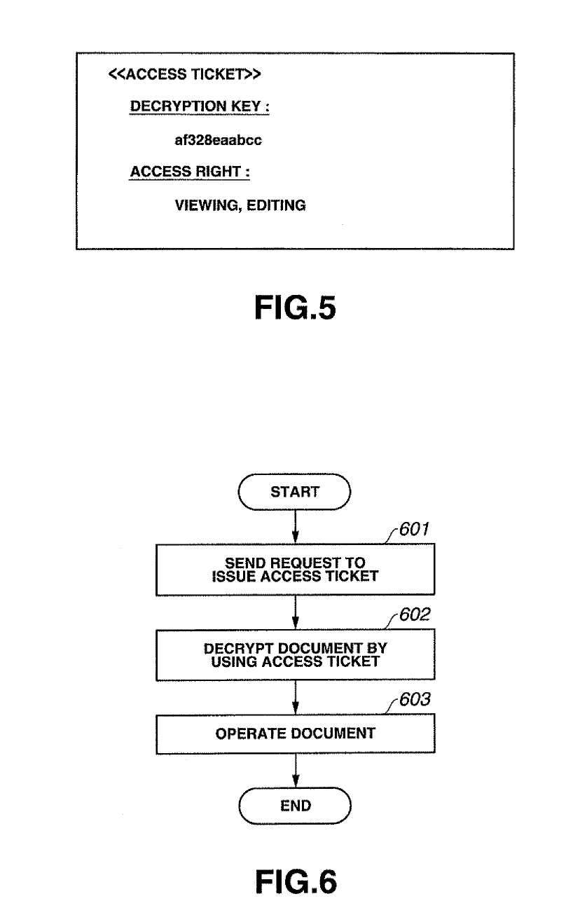

FIG. 5 shows an example of the access ticket, which includes a decryption key for decrypting the capsulized document, and the second operation restriction information for operating the document decrypted with the decryption key in the non-managed state.

The access ticket management device 200 sends the generated access ticket to the client PC 300 (requester), and the client PC 300 stores the access ticket.

The client PC 300 decrypts the downloaded capsulized document by using the decryption key included in the received access ticket, and performs the operation permitted by the second operation restriction information in the access ticket.

It should be noted that FIG. 1 shows the configuration including the document management system 100, the access ticket management device 200 and the client PC 300. However, the configuration is not limited to this. It may be possible to employ a configuration in which the document management device 101 in the document management system 100 has functions of the access ticket management device 200. Alternatively, there may exist plural document management devices 100 or access ticket management devices 200.

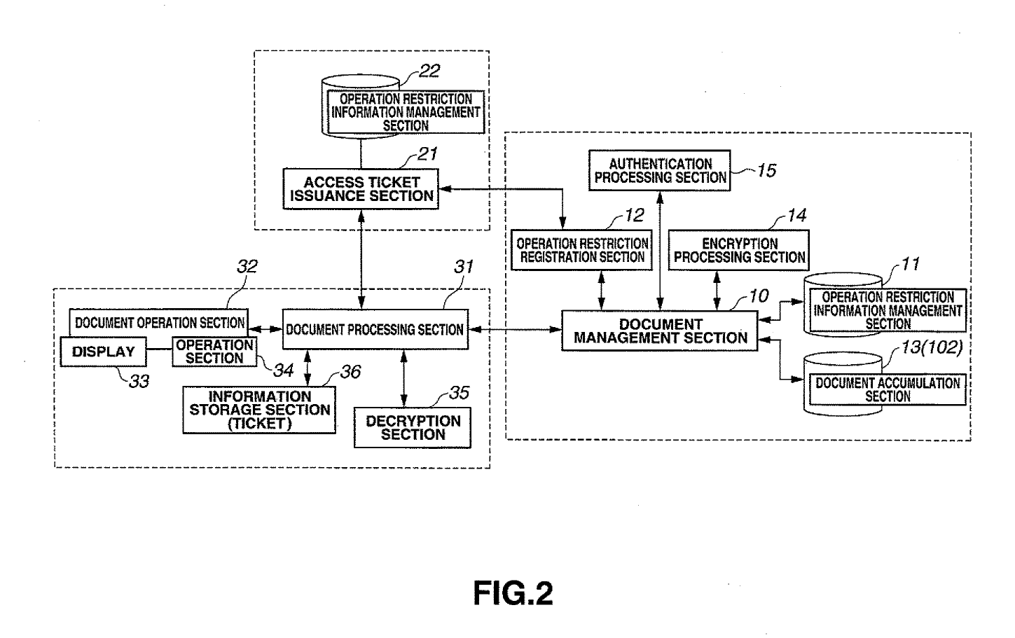

FIG. 2 is a block diagram showing a functional configuration of the operation management system according to the exemplary embodiment of the present invention.

In FIG. 2, the operation management system includes a document management section 10, an operation restriction information management section 11, an operation restriction registration section 12, a document accumulation section 13, an encryption processing section 14, an authentication processing section 15, an access ticket issuance section 21, an operation restriction information management section 22, a document processing section 31, a document operation section 32, a display 33, an operation section 34, a decryption section 35, and an information storage section 36.

In the system configuration shown in FIG. 1, one configuration is given as an example in which the document management system 100 realizes functions of the document management section 10, the operation restriction information management section 1, the operation restriction registration section 12, the document accumulation section 13, the encryption processing section 14, and the authentication processing section 15; the access ticket management device 200 realizes functions of the access ticket issuance section 21, and the operation restriction information management section 22; and the client PC 300 realizes the document processing section 31, the document operation section 32, the display 33, the operation section 34, the decryption section 35, and the information storage section 36.

It is understood that the system configuration is not limited to the configuration above, and it may be possible to employ a configuration in which all the functions of the access ticket management device 200 are realized by the document management device 101 in the document management system 100.

Once a user who operates the document using the client PC 300 is authenticated by an authentication device (not shown), and the user gives an instruction to request to operate the document through the document operation section 32 in a state where the authentication information (hereinafter, “user authentication information”) is stored in the information storage section 36, the operation request is sent to the document processing section 31. Note that authentication of the user is not essential configuration in the present invention, provided that the document management system 100 or the access ticket management device 200 can identify the user who uses the client PC 300. In this example, however, the configuration in which user authentication is performed is shown as one example.

The document operation section 32 is made up of the display 33 formed by a display unit and so on, and the operation section 34 formed by a keyboard, a pointing device, etc. With the display 33 and the operation section 34, the document to be operated is designated, and such operation as viewing or editing the document is implemented.

With the document operation section 32, the document processing section 31 requests the document management section 10 for downloading the document accumulated in the document accumulation section 13. And, the download request includes information for identifying the user who makes the request and authentication information obtained as a result of user authentication.

The document management section 10 manages documents accumulated in the document accumulation section 13 formed by a database, etc. The document management section 10 generates the operation restriction information for the document of which download request is made from the document processing section 31, and registers the generated operation restriction information to the operation restriction information management section 11.

Additionally, the document management section 10 requests the authentication processing section 15 to check the validity of the authentication information obtained as a result of the authentication of the user who makes the download request. The authentication processing section 15 checks the authentication information by using a signature issued by a third-party certification authority, etc., and responds to the document management section 10.

If the authentication processing section 15 confirms the authentication information of the user, the document management section 10 requests the encryption processing section 14 to encrypt the document.

The encryption processing section 14 generates a capsulized document by encrypting the document. Then, the document management section 10 sends the capsulized document to the document processing section 31, which is a requester At the same time, the document management section 10 sends to the access ticket issuance section 21 a relationship between the generated second operation restriction information and document identification information for identifying the document.

The access ticket issuance section 21 registers the received relationship to the operation restriction information management section 22. As a result, the operation restriction information for the document is managed by the operation restriction information management section 22.

Upon receiving the capsulized document, the document processing section 31 requests the access ticket issuance section 21 to issue an access ticket to operate the capsulized document. After receiving the request, the access ticket issuance section 21 determines whether the issuance of the access ticket is permissible on the basis of the relationship between the second operation restriction information managed in the operation restriction information management section 22 and the document identification information. The access ticket issued at this time is an access ticket previously associated with. Alternatively, it may be possible to generate and issue the access ticket on the basis of previously designated source information for generating the access ticket.

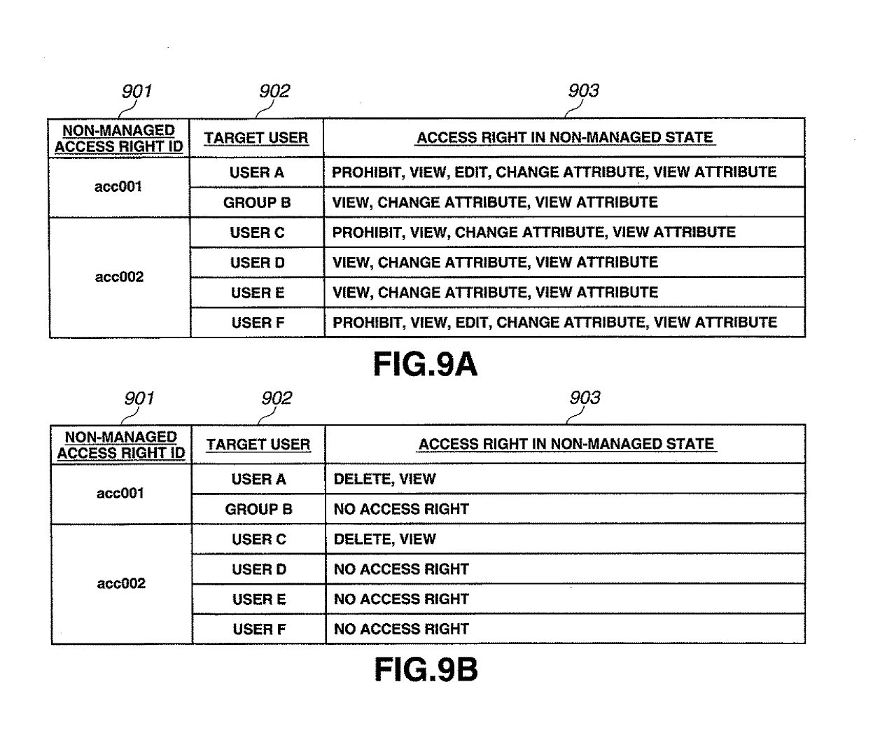

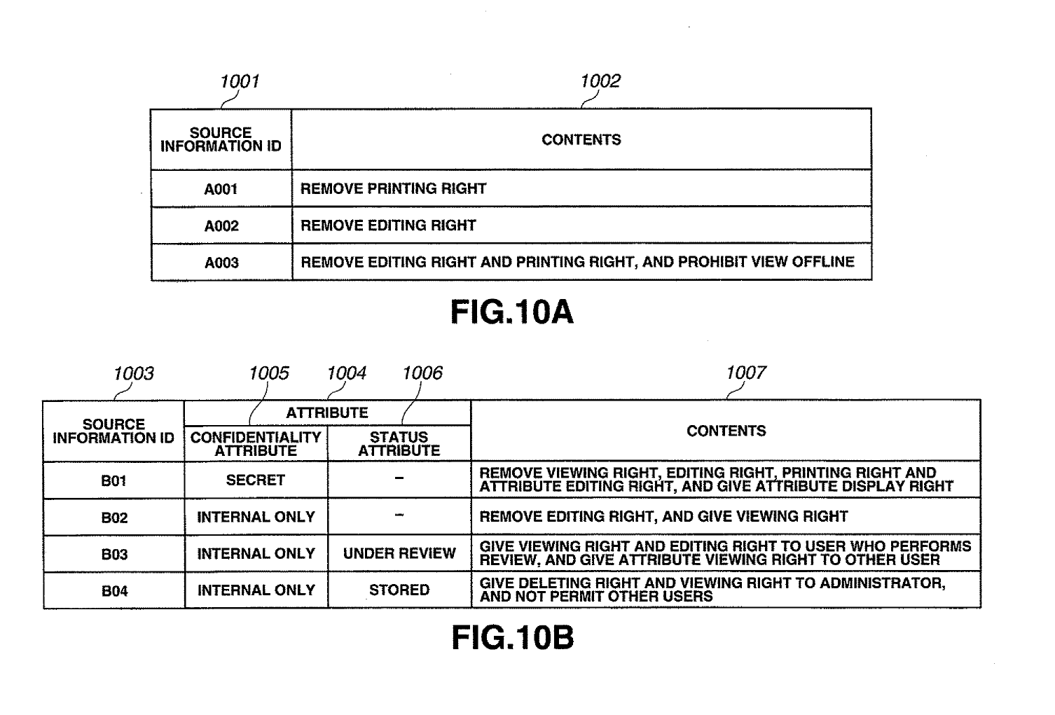

An example for generating the access ticket on the basis of the source information in this case will be described using FIGS. 9A, 9B, 10A, and 10B.

The access ticket includes the decryption key for decrypting the document in a capsulized state into a plain text, and the second operation restriction information for restricting the operation of the decrypted document in the plain text. The access ticket including those pieces of information is sent to the document processing section 31.

After receiving the access ticket, the document processing section 31 stores the received access ticket to the information storage section 36.

Then, when an instruction to operate the capsulized document is given from the document operation section 32, the document processing section 31 requests the decryption section 35 to decrypt the capsulized document by using the information of the access ticket stored in the information storage section 36. After the decryption section 35 performs the decryption with the decryption key included in the access ticket, the document processing section 31 restricts the operation on the basis of the second operation restriction information included in the access ticket.

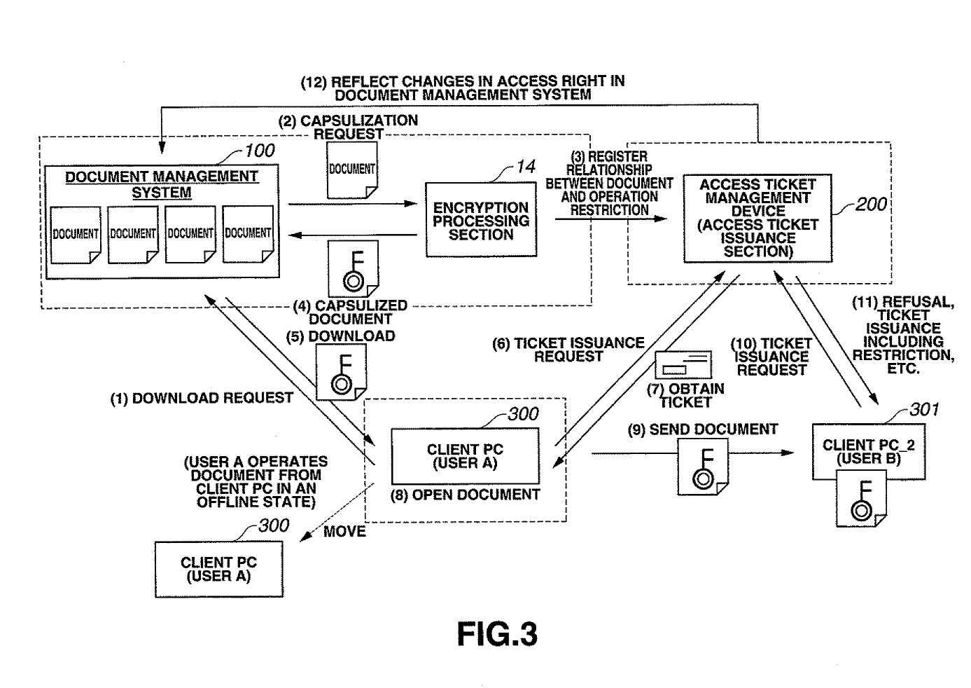

FIG. 3 is a diagram showing a schematic configuration of the operation management system according to the exemplary embodiment of the present invention.

FIG. 3 shows the document management system 100, the access ticket management device 200, and the client PC 300. In FIG. 3, the encryption processing section 14 is shown as part of the document management system 100, and a client PC_2 301 is shown as an example of other client PC.

A state transition of a document in the above-described configuration will be described below.

In a case when a user A operates a document managed in the document management system 100 using the client PC 300, authentication of the user A who is an operator of the document is first performed using an authentication function of the document management system 100. For the authentication processing above, an authentication server (not shown) may be separately provided to perform the authentication of the user A through communication between the authentication server and the client PC 300.

In a state where an operator of the client PC 300 is already authenticated as the user A as described above, when a request (obtainment request) to download a prescribed document (“document A” as one example of the document) is made from the client PC 300 to the document management system 100, the document management system 100 that manages the document retrieves the document of which download request is made, and requests the encryption processing section 14 to capsulize the retrieved document (document A).

Note that, in the configuration shown in FIGS. 1 and 2, the encryption processing section 14 constitutes a portion of the document management system 100.

Upon receiving the capsulization request, the encryption processing section 14 encrypts the document A using a prescribed encryption algorithm, sends the document encrypted through the encryption processing (“capsulized document A”) to the document management system 100, which is the requester, and registers the relationship between the document information of the encrypted document A and the second operation restriction information to the access ticket management device 200.

The second operation restriction information registered in the access ticket management device 200 is used for decrypting the encrypted document and determining whether to permit the operation of the capsulized document. Thus, the access ticket management device 200 holds the decryption key for decrypting the encrypted capsulized document, and the second operation restriction information for restricting operations performed by the user A who uses the client PC 300.

Then, after receiving the capsulized document from the encryption processing section 14, the document management system 100 sends the capsulized document A to the client PC 300, which is a download requester.

Through the process above, the client PC 300 is made into a state where the client PC 300 obtains the document of which the download request is made.

Then, to make the capsulized document A downloaded from the document management system 100 operable, the client PC 300 requests the access ticket management device 200 to issue an access ticket (hereinafter, also referred to as “ticket”).

After receiving the request to issue the ticket from the client PC 300, the access ticket management device 200 generates the ticket including the information for restricting the document operation and the decryption key for decrypting the capsulized document for the user (user A) who operates the client PC, which is the issuance requester, on the basis of the relationship between the document registered by the encryption processing section 14 and the operation restriction information, and then sends the generated ticket to the client PC 300, which is a requester.

Through the process above, in a case where the document is downloaded from the document management system 100 to the client PC 300 to operate, the user A can operate the capsulized document A within the permitted range indicated in the ticket. For example, if the viewing operation and the editing operation are permitted, the document can be viewed and edited. As a result, it becomes possible to separately apply to the same document the operation restriction information (second operation restriction information), which is different from the operation restriction information (first operation restriction information) applied when the user A requests to view and operates the document managed in the document management system.

Next, a description will be made of a case where, in a state where the client PC 300 receives the ticket, the capsulized document is sent from the client PC 300 operated by the user A to a client PC_2 301 operated by a user B through such function as e-mail or file transfer

In this case, the client PC_2 301 requests the access ticket management device 200 to issue a ticket as is the case with the client PC 300.

At this time, the access ticket management device 200 retrieves information necessary for generating the ticket to be issued such as the decryption key and the operation restriction information on the basis of the relationship between the document registered by the encryption processing section 14 and the operation restriction information. In this case, if it is determined that those pieces of information are not registered by the encryption processing section 14, the access ticket management device 200 does not issue the ticket.

Through the processing above, the capsulized document cannot be decrypted in the client PC_2 301 operated by the user B, and is not allowed to operate by the operation restriction.

If the information necessary for generating the ticket to be issued such as the decryption key and the operation restriction information is registered, the ticket generated on the basis of the right information applicable to the user B is issued.

In a case when the client PC 300 is realized by a notebook PC or other mobile terminals, and is made into an offline state where communication with the access ticket management device is impossible, operation is allowed to be performed on the basis of the operation restriction information indicated in the ticket obtained from the access ticket management device 200.

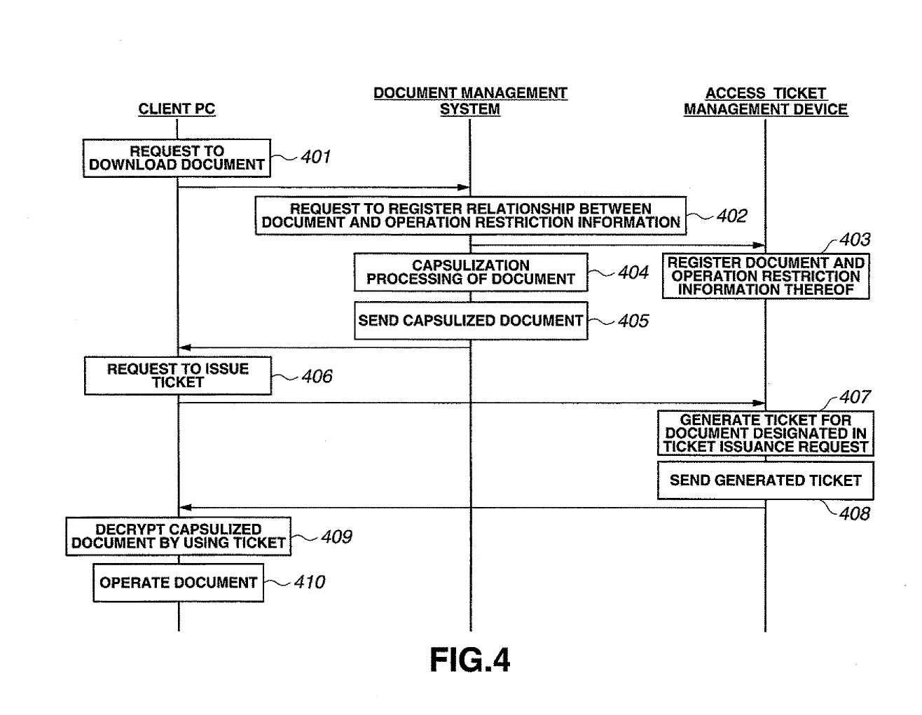

FIG. 4 is a sequence diagram showing a state transition of the operation management system according to the exemplary embodiment of the present invention.

FIG. 4 shows the state transition of the system configuration shown in FIG. 1. Processing is started when a request to download a document (document A) managed in the document management system is made from a client PC in a state where a user A who operates the client PC is already authenticated (401).

This document download request includes information for designating the “document A” to be operated, and the user information on the authenticated user. Upon receiving the download request, the document management system retrieves the document A from the managed documents, and sends the relationship between the document A and the operation restriction information to the access ticket management device (402).

The document management system stores the operation restriction information in which the restriction on document operation is specified in advance, and sends the retrieved document A and the operation restriction information corresponding to the document A to the access ticket management device. Additionally, the second operation restriction information may be generated upon receiving the download request on the basis of the already specified first operation restriction information, or may be generated on the basis of the attribution of the document. For example, in a case of generation on the basis of the already specified first operation restriction information, the operation permitted by the second operation restriction information may be set only to “browsing” for the purpose of applying further restriction when the operation permitted by the first operation restriction information is set to “printing and browsing.”

Furthermore, when generated on the basis of the attribution of the document, the second operation restriction information can be generated, for example, on the basis of a type of the document, confidential level of the document, status of the document, and so on. The type of the document includes “written agreement,” “design specifications,” etc.; the confidential level of the document includes “for internal use only,” “top secret,” etc.; and the status of the document includes “now drafting,” “approved,” etc. The second operation restriction information may be generated from those elements as needed. In addition to that, the generation may be performed considering the position or role of the user who makes the download request.

After receiving the document A and the second operation restriction information, the access ticket management device registers those pieces of information (403).

Additionally, the document management system encrypts the document A retrieved in response to the download request on the basis of the prescribed encryption algorithm, and generates a capsulized document (404). Then, the document management system sends the generated capsulized document to the client PC, which is a requester (405),

Then, upon receiving the document A, which is an object of the download request, the client PC requests the access ticket management device to issue the access ticket (ticket) necessary for operating the document A. The access ticket management device generates the access ticket for the document A designated by the issuance request (407).

In the access ticket generation processing above, the ticket including the decryption key for decrypting the encrypted document and the second operation restriction information is generated on the basis of the document A and the second operation restriction information corresponding the document A, which are registered by the document management system. Needless to say, it may be possible to employ a configuration of using the access ticket generated in advance.

After generating the access ticket, the access ticket management device sends the generated access ticket to the client PC, which is a requester of the ticket issuance (408).

Upon receiving the access ticket, the client PC decrypts the capsulized document with the decryption key included in the access ticket (409), and operates the decrypted document A on the basis of the second operation restriction information (410).

It should be noted that, in the description above, the access ticket is issued by the access ticket management device, and the document A, which is an operation target, is operated based on the access ticket. However, the configuration is not limited to this. It may be possible to employ a configuration in which the document A, which is the operation target, is downloaded from the document management system, and the operation restricted by the second operation restriction information included in the ticket is performed only when the client PC that receives and stored the ticket is transferred into an offline state where communication with the document management system is impossible.

In other words, if the client PC that operates the document is in a state where intercommunication with the document management system is possible, it may be possible to operate the document on the basis of the first operation restriction information managed by the document management system.

FIGS. 5 is a diagram showing one example of the access ticket used in the operation management system in the exemplary embodiment of the present invention.

The access ticket shown in FIG. 5 includes at least the decryption key for decrypting the encrypted document, and the second operation restriction information, and is generated and issued by the access ticket management device 200 shown in FIG. 1.

The access ticket is information managed in the access ticket management device and generated on the basis of the relationship between the document information received from the document management system and the second operation restriction information. Additionally, this access ticket is information referred to when the client PC that operates the document operates the downloaded document.

In the access ticket shown in FIG. 5, “af328eaabcc” is given as one example of the decryption key. This access ticket also includes the operation restriction information for restricting operations in an offline state.

FIG. 6 is a flow chart illustrating a flow of processing of the client PC in the operation management system according to the exemplary embodiment of the present invention.

In FIG. 6, the processing starts by making the request to download the document managed by the document management device, and downloading the capsulized document. At the time of operating the capsulized document, the client PC requests the access ticket management device to issue the access ticket (601).

Upon receiving the ticket from the access ticket management device, the client PC decrypts the document with the access ticket (602).

Then, the client PC operates the decrypted document on the basis of the operation restriction information included in the access ticket (603).

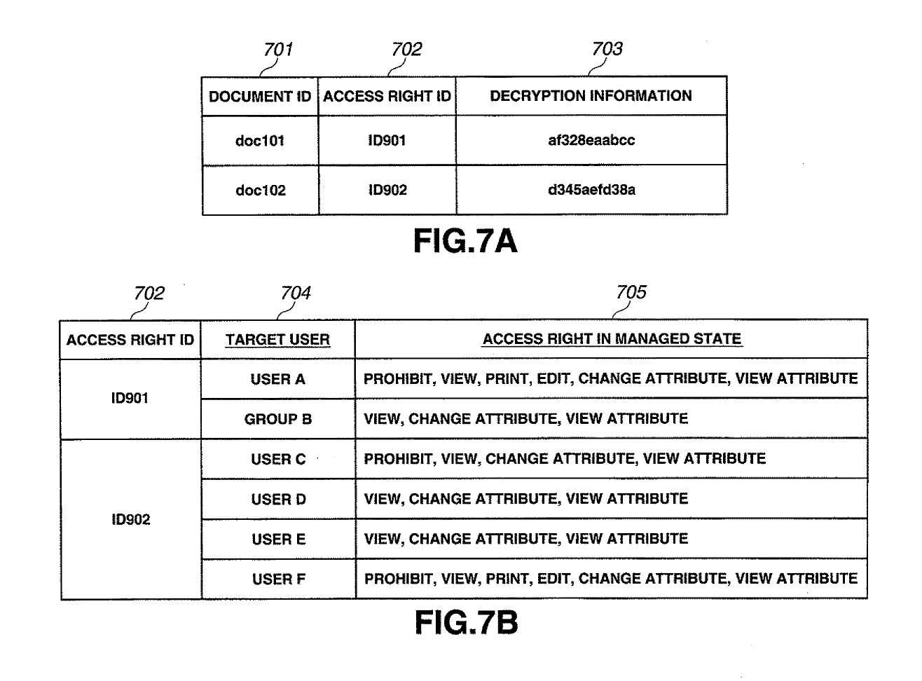

FIGS. 7A and 7B are table configuration diagrams showing restriction information at the time when the document is operated in the managed state in the operation management system according to the exemplary embodiment of the present invention.

In other words, the information above is information for restricting operations of documents when, in the configuration shown in FIG. 1, the client PC 300 requests to view and operates the document in the document management device 101, and includes the first operation restriction information in the present invention.

In FIGS. 7A and 7B, FIG. 7A shows the operation restriction information and the decryption information for the document, and is formed by [document ID] item 701, [access right ID] item 702, and [decryption information] item 703. The [document ID] item 701 shows information for identifying the document to be operated; the [access right ID] item 702 shows identification information identifying the operation restriction information for restricting operations of documents identified by the identification information shown in the [document ID] item 701; and the [decryption information] item 703 shows decryption keys for decrypting the documents identified by the identification information shown in the [document ID] item 701.

FIG. 7B is information indicating target users and contents of the operation restriction that correspond to the identification information identifying the operation restriction information shown in the [access right ID] item 702.

FIG. 7B is formed by [access right ID] item 702, [target user] item 704, and [access right in managed state] item 705. In FIG. 73, the [target user] item 704 indicating a user who operates the document and the [access right in managed state] item 705 indicating permitted document operations are provided in association with the identification information identifying the operation restriction information indicated in the [access right ID] item 702.

For example, in a case where the [document ID] item 701 is “doc101,” the [access right ID] item 702 is “ID901,” and the [decryption information] item 703 is “af328eaabcc” as shown in FIG. 7A, the access right set for the document identified by the identification information “doc101” is identified by “ID901,” and the document “doc101” can be operated by decrypting the encrypted document with the decryption key of “af328eaabcc.”

Additionally, the contents of the operation restriction identified by the access right “ID901” are provided in the [access right in managed state] item 705 for a user identified by the [target user] item 704 in FIG. 7B. This means that the “user A” is permitted to implement operations of “prohibiting, viewing, printing, editing, changing attribute, and viewing attribute.”

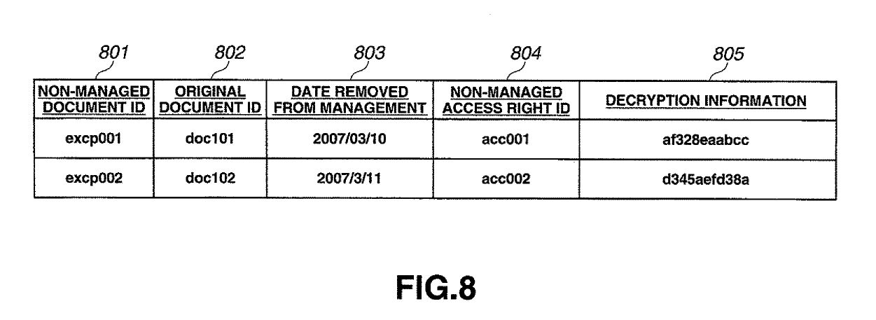

FIG. 8 is a table configuration diagram showing information for managing a document that becomes in the non-managed state in the operation management system according to the exemplary embodiment of the present invention.

The table shown in FIG. 8 includes [non-managed document ID] item 801, [original document ID] item 802, [date removed from management] item 803, [non-managed access right ID] item 804, and [decryption information] item 805.

The [non-managed document ID] item 801 is information for identifying a document downloaded by the client PC from the document management device, and identifies the document removed from the management by the document management device. The [original document ID] item 802 is identification information for identifying a document in a state where the document is managed by the document management device.

The [date removed from management] item 803 is a date when the non-managed document ID shown in the [non-managed document ID] item 801 is applied because the document is brought into the non-managed state. The [non-managed access right ID] item 804 is information for identifying the operation restriction information, and is applied when the document is brought into the non-managed state. The [decryption information] item 805 is information indicating the decryption key for decrypting the capsulized document.

For example, description will be made of a case when the [non-managed document ID] item 801 is “excp001,” the [original document ID] item 802 is “doc101,” the [date removed from management] item 803 is “Mar. 10, 2007,” the [non-managed access right ID] item 804 is “acc001,” and the [decryption information] item 805 is “af328eaabcc.”

In this case, the non-managed document ID applied to the document that becomes in the non-managed state is “excp001”; the document identified by this identification information is brought into the non-managed state on “Mar. 10, 2007”; and the document identified by the non-managed document ID “excp001” is managed by using the original document ID “doc101” at the time when the document is managed by the document management device. Additionally, the operation restriction information identified by the non-managed access right ID “acc001” is applied to the document identified by the non-managed document ID “excp001,” and the document “excp001” is decrypted with the decryption information “af328eaabcc.”

FIGS. 9A and 9B are diagrams showing examples of the operation restriction information for restricting operations of the document that becomes in the non-managed state in the operation management system according to the exemplary embodiment, namely, the second operation restriction information of the present invention.

FIGS. 9A and 9B are examples of the operation restriction information to which the client PC refers when the document is operated in the non-managed state, and those pieces of operation restriction information are provided as examples of the operation restriction information generated on the basis of the information shown in FIGS. 10A and 10B. In other words, FIGS. 10A and 10B show source information that forms the basis for generating the operation restriction information shown in FIGS. 9A and 9B.

It is understood that it may be possible to employ a configuration in which the operation restriction information as shown in FIGS. 9A and 9B is stored in advance.

FIG. 9A is the operation restriction information in the non-managed state generated on the basis of the source information shown in FIG. 10A. FIG. 9B is the operation restriction information in the non-managed state generated on the basis of the source information shown in FIG. 10. FIGS. 9A and 9B are formed by [non-managed access right ID] item 901, [target user] item 902, and [access right in non-managed state] item 903.

The [non-managed access right ID] item 901 is identification information for identifying the operation restriction information in the non-managed state, and corresponds to the identification information shown in the [non-managed access right ID] item 804 in FIG. 8.

The [target user] item 902 indicates a user to which the operation restriction information in the non-managed state is applied, and the [access right in non-managed state] item 903 is restriction information for restricting document operations.

Next, FIGS. 10A and 10B will be described.

FIGS. 10A and 10B are source information that forms the basis for generating the operation restriction information in the non-managed state shown in FIGS. 9A and 9B. The source information is information that indicates how the operation restriction information in the managed state as shown in FIG. 7B is modified to obtain the operation restriction information in the non-managed state.

FIG. 10A shows three pieces of source information. For example, as for the source information identified by “A001” in [source information ID] item 1001, it is indicated that the operation restriction information in the non-managed state is generated by “removing the right for printing,” which is specified in the [contents] item 1002, from the operation restriction information in the managed state.

The operation restriction information in the non-managed state generated through the manner above is shown in FIG. 9A.

FIG. 10B shows four pieces of source information. Those pieces of source information are specified on the basis of an attribute of the document to be operated.

For example, in a case of the source information identified by “B04” in the [source information ID] item 1003, the [contents] item 1007 specifies the operation restriction information at the time of operating in the non-managed state the document whose confidentiality attribute is “internal only” and status attribute is “stored,” each of which is shown in the [attribute] item 1004, and indicates that “the deleting right and the viewing right are given to an administrator, and not permit other users”.

The operation restriction information in the non-managed state generated by using the source information is shown in FIG. 9B.

In other words, FIG. 9A is the operation restriction information for the document in the non-managed state, which is generated on the basis of the source information of “removing the printing right” in FIG. 10A. FIG. 9A shows a state where the printing right is removed from all the pieces of the operation restriction information.

Additionally, FIG. 9B is the operation restriction information for the document in the non-managed state, which is generated on the basis of the source information of “the deleting right and the viewing right are given to an administrator, and not permit other users” in FIG. 10B. In FIG. 9B, the “user A” and “user C,” who have administrator authority, are permitted to “delete and view” the document, and all the operations performed by other users and group are “not permitted.”

As described above, operations can be appropriately controlled even in a case where the document management is changed from the managed state by the document management device to the non-managed state.

It should be noted that, in the present invention, it may possible to employ a configuration in which the operation management system is caused to execute the processing as described above by causing the operation management system having a communication function to implement the operations as described above, or by installing a program for configuring the means as described above from a recording medium (CD-ROM, DVD-ROM, etc.) storing the program to a computer and causing the computer to execute the program. In the computer, which forms the operation management system, a CPU (Central Processor Unit), a ROM (Read Only Memory), and a hard disk are connected through a system bus. The CPU executes the processing in accordance with the program stored in the ROM or the hard disk using the RAM as an operational space.

Additionally, it may be possible to employ a communication medium (medium that temporarily or dynamically maintains the program as in the case of the communication lines or communication system) as the medium for providing the program. For example, the program may be posted to the electronic bulletin board (BBS: Bulletin Board Service) on the communication network, and be distributed through the communication lines.

The present invention is not limited to the example described above or shown in the drawings, and may be implemented by being modified appropriately without departing from the spirit and scope thereof.

The foregoing description of the exemplary embodiment of the present invention is provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An operation management system, comprising:
a document management device that manages a document; and
a document operation device that requests for viewing of or obtains the document managed by the document management device to operate, wherein
the document management device comprises:
an operation restriction information management section that manages first operation restriction information for restricting an operation of the document for which viewing is requested from the document operation device to the document management device to operate and which is operated by a user of the document operation device, and second operation restriction information generated on the basis of the first operation restriction information, for restricting the operation of the document obtained from the document management device by the document operation device to operate and operated by the user of the document operation device; and
an issuance section that issues the second operation restriction information managed by the operation restriction information management section to the document operation device, and
the document operation device comprises an operation restriction section that restricts the operation of the document on the basis of the second operation restriction information issued by the issuance section when the document is obtained from the document management device to operate.

2. The operation management system according to claim 1, wherein
the document management device further comprises an operation restriction information generation section that generates the second operation restriction information when a request to obtain the second operation restriction information is made by the document operation device, and
the operation restriction information management section manages the second operation restriction information generated by the operation restriction information generation section.

3. The operation management system according to claim 2, wherein
the operation restriction information generation section generates the second operation restriction information on the basis of a combination of attribute information of the document and the first operation restriction information for restricting the operation of the document.

4. The operation management system according to claim 1, wherein
the document operation device obtains an encrypted document;
the issuance section issues an access ticket including decryption information for decrypting the encrypted document and the second operation restriction information; and
the document operation device decrypts the document on the basis of the decryption information included in the access ticket issued by the issuance section and operates the decrypted document.

5. The operation management system according to claim 1, wherein
the issuance section issues an access ticket including using location information for restricting a using location of the document, and
the document operation device restricts the operation of the document on the basis of the using location information included in the access ticket issued by the issuance section.

6. The operation management system according to claim 1, wherein
the issuance section issues an access ticket including time information for restricting a using time of the document, and
the document operation device restricts the operation of the document on the basis of the time information included in the access ticket issued by the issuance section.

7. The operation management system according to claim 1, wherein
the issuance section issues an access ticket including environment information for restricting a using environment of the document, and
the document operation device restricts the operation of the document on the basis of the environment information included in the access ticket issued by the issuance section.

8. The operation management system according to claim 1, wherein
the issuance section issues an access ticket including user information for restricting a user of the document, and
the document operation device restricts the operation of the document on the basis of the user information included in the access ticket issued by the issuance section.

9. The operation management system according to claim 1, wherein
the document management device further comprises an update section that updates the second operation restriction information in correspondence with an update in the first operation restriction information managed by the operation restriction information management section.

10. An operation management method, comprising:
managing a document;
making a viewing request to view or obtaining the managed document to operate;
managing first operation restriction information for restricting an operation of the document for which the viewing request is made to operate and which is operated by a user, and second operation restriction information generated on the basis of the first operation restriction information, for restricting the operation of the document obtained to operate and operated by the user;
issuing the managed second operation restriction information; and
restricting the operation of the document on the basis of the issued second operation restriction information when the document is obtained to operate.

11. A computer readable recording medium storing an operation management program that causes a computer to execute a process, the process comprising:
managing a document;
making a viewing request to view or obtaining the managed document to operate;
managing first operation restriction information for restricting an operation of the document for which the viewing request is made to operate and which is operated by a user, and second operation restriction information generated on the basis of the first operation restriction information, for restricting the operation of the document obtained to operate and operated by the user;
issuing the managed second operation restriction information; and
restricting the operation of the document on the basis of the issued second operation restriction information when the document is obtained to operate.

12. A computer data signal embodied in a carrier wave for enabling a computer to perform a process for operation management, the process comprising:
managing a document:
making a viewing request to view or obtaining the managed document to operate;
managing first operation restriction information for restricting an operation of the document for which the viewing request is made to operate and which is operated by a user, and second operation restriction information generated on the basis of the first operation restriction information, for restricting the operation of the document obtained to operate and operated by the user;
issuing the managed second operation restriction information; and
restricting the operation of the document on the basis of the issued second operation restriction information if the document is obtained to operate.
